(19) United States
(12) Patent Application Publication
(10) Pub. No.: US 2014/0002984 A1
(43) Pub. Date: Jan. 2, 2014

(54) BASE FOR HARD DISK DRIVE AND HARD DISK DRIVE HAVING THE SAME

(71) Applicant: Tae Young Choi, Gyunggi-do (KR)

(72) Inventor: Tae Young Choi, Gyunggi-do (KR)

(73) Assignee: SAMSUNG ELECTRO-MECHANICS CO., LTD., Gyunggi-do (KR)

(21) Appl. No.: 13/599,029

(22) Filed: Aug. 30, 2012

(30) Foreign Application Priority Data
Jun. 28, 2012 (KR) 10-2012-0070032

(51) Int. Cl. G06F 1/16

(52) U.S. Cl. 361/679.33

(57) ABSTRACT

Disclosed herein is a base for a hard disk drive, including: a base plate; and a double bent part doubly bent from an outer edge of the base plate, wherein a thickness of a plate material forming the double bent part is thinner than that of a plate material forming the base plate. The plate material of the base plate including a central portion of the base and the plate material of the double bent part formed at an outer side of the base have a relative difference in a thickness therebetween, thereby making it possible to secure rigidity at both of the central portion of the base and the outer side of the base.

### CROSS REFERENCE TO RELATED ED APPLICATION

This application claims the benefit of Korean Patent Application No. 10-2012-0070032, filed on Jun. 28, 2012, entitled “Base for Hard Disk Drive and Hard Disk Drive Having the Same”, which is hereby incorporated by reference in its entirety into this application.

### BACKGROUND OF THE INVENTION

1. Technical Field

The present invention relates to a base for a hard disk drive and a hard disk drive having the same.

2. Description of the Related Art

Generally, a spindle motor which belongs to a brushless-DC motor (BLDC) has been widely used as a laser beam scanner motor for a laser printer, a motor for a floppy disk drive (FM), a motor for an optical disk drive such as a compact disk (CD) or a digital versatile disk (DVD), or the like, in addition to a motor for a hard disk drive.

Particularly, a base used in the hard disk drive is installed with the spindle motor as described above, forms an appearance of the hard disk drive, and is coupled to a printed circuit board. The hard disk drive is connected to a personal computer (PC) by a connector of the printed circuit board. Generally, the base is manufactured by processing an aluminum material by a die-casting method and performing an additional detailed process. However, in the case of manufacturing the base using the die-casting method, a lead time of production increases, such that productivity is deteriorated, and a separate process is added after the die-casting, such that a process becomes complicated and troublesome. Therefore, in order to solve these problems, it has been required to manufacture a base by a press processing method considering quality and productivity of a product.

However, in the case of manufacturing the base by the press processing method, it is general to use a plate material having a predetermined thickness for the press processing. Therefore, in the case of increasing the thickness of the plate material for rigidity, a limitation is generated in a degree of freedom in a structural design. In addition, in the case of decreasing the thickness of the plate material for a portion requiring a structural design for increasing the rigidity of the base, the rigidity of the base such as a decrease in rigidity of a portion at which the structural design is not made and other design problems have been generated.

### SUMMARY OF THE INVENTION

The present invention has been made in an effort to provide a base capable of having increased rigidity by forming a double bent part at one side end of a base plate and capable of having entirely increased rigidity by a relative difference in a thickness between the double bent part and a central portion of the base plate, and a spindle motor having the same.

According to a preferred embodiment of the present invention, there is provided a base for a hard disk drive including: a base plate; and a double bent part doubly bent from an outer edge of the base plate, wherein a thickness of a plate material forming the double bent part is thinner than that of a plate material forming the base plate.

The double bent part may include: a first bent part extended upwardly from one surface of the base plate and bent outwardly of the base plate; and a second bent part extended from the first bent part and again bent downwardly toward the other surface of the base plate.

The first bent part and the second bent part may have a flat part formed therebetween, wherein the flat part is in parallel with one surface of the base plate.

When the thickness of the plate material forming the base plate is 0.8 or more to 1.0 mm or less, the thickness of the plate material forming the double bent part may be 0.6 or more to below 0.8 mm.

The thickness of the plate material forming the double bent part may be thinner than that of the plate material forming a central portion of the base plate including a seat part on which a spindle motor is seated.

When the thickness of the plate material forming the central portion of the base plate is 0.8 or more to 1.0 mm or less, the thickness of the plate material forming the double bent part may be 0.6 or more to below 0.8 mm.

According to another preferred embodiment of the present invention, there is provided a hard disk drive including a spindle motor seated on a seat part of a base, wherein the spindle motor includes: a shaft forming a rotation center of the motor; a sleeve receiving the shaft therein and rotatably supporting the shaft; the base having one side surface coupled to an outer side surface of the sleeve so as to enclose the outer side surface of the sleeve to support the sleeve and having a core mounted on an inner side surface thereof, the core having a coil wound therearound; and a hub coupled to an upper portion of the shaft in an axial direction, having one side end bent in a downward axial direction, and having a rotor magnet formed on an inner side surface thereof so as to correspond to the core in a radial direction, the base including: a base plate including the seat part on which the spindle motor is seated; and a double bent part doubly bent from an outer edge of the base plate, and a a thickness of a plate material forming the double bent part being thinner than that of a plate material forming the base plate.

The double bent part may include: a first bent part extended upwardly from one surface of the base plate and bent outwardly of the base plate; and a second bent part extended from the first bent part and again bent downwardly toward the other surface of the base plate.

The first bent part and the second bent part may have a flat part formed therebetween, the flat part being in parallel with one surface of the base plate.

When the thickness of the plate material forming the base plate is 0.8 or more to 1.0 mm or less, the thickness of the plate material forming the double bent part may be 0.6 or more to below 0.8 mm.

The thickness of the plate material forming the double bent part may be thinner than that of the plate material forming a central portion of the base plate including a seat part on which a spindle motor is seated.

When the thickness of the plate material forming the central portion of the base plate is 0.8 or more to 1.0 mm or less, the thickness of the plate material forming the double bent part may be 0.6 or more to below 0.8 mm.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a base for a hard disk drive according to a preferred embodiment of the present invention;

FIG. 2 is a cross-sectional view taken along the line A-A′ of FIG. 1; and

FIG. 3 is a partial cross-sectional view of a hard disk drive in which a spindle motor is seated on the base for a hard disk drive according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

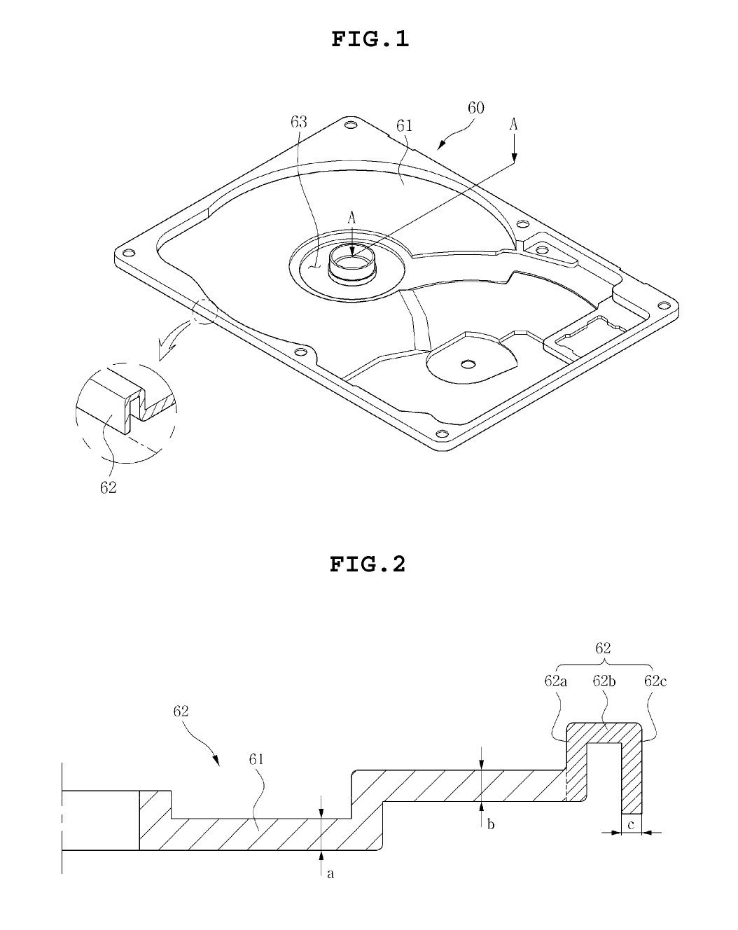

FIG. 1 is a perspective view of a base for a hard disk drive according to a preferred embodiment of the present invention; and FIG. 2 is a cross-sectional view taken along the line A-A′ of FIG. 1.

The base 60 for a hard disk drive according to the preferred embodiment of the present invention may be configured to include a base plate 61; and a double bent part 62 doubly bent from an outer edge of the base plate 61, wherein a thickness of a plate material forming the double bent part 62 may be thinner than that of a plate material forming the base plate 61.

Particularly, in order to maintain and increase rigidity of the base 60 when the base 60 is manufactured by press processing, a thickness of a plate material used for the press processing needs to be adjusted. However, the maintenance of the rigidity of the base 60 through the increase of the thickness of the plate material generates a limitation in a design and is not in accordance with a technical trend toward the miniaturization of the spindle motor. Therefore, a base rigidity maintaining structure for increasing the rigidity of the base 60 while being in accordance with the trend toward the thinness and the miniaturization of the spindle motor is required. According to the preferred embodiment of the present invention, this object is accomplished by forming the double bent part 62 at the outer edge of the base 60. In order to increase the rigidity at both of the central portion and the outer edge of the base plate 61, the plate material of the central portion of the base plate 61 and the plate material forming the double bent part 62 bent from the outer edge of the base plate 61 are designed to have a relative difference in a thickness therebetween, thereby making it possible to implement a more effective base rigidity maintaining structure. Hereinafter, a configuration for these features of the present invention and a hard disk drive in which the base 60 and the spindle motor are mounted will be described.

The base plate 61, which forms an appearance of various components such as the spindle motor, a head assembly (not shown), and the like, of the hard disk drive, may be coupled to a cover member (not shown) to thereby be connected to a personal computer (PC), or the like. In addition, a printed circuit board 70 is formed on one surface of the base plate 61 to electrically connect the base plate 61 to the outside. Here, the base plate 61 may be formed of aluminum, an aluminum alloy material, a steel plate, or the like. In addition, the base 60 for a hard disk drive including the base plate 61 may be manufactured by a press processing method. Therefore, a lead time of production is reduced, such that mass production becomes easy, and an additional separate process is omitted, such that productivity is improved. Further, the process is simplified, such that a production cost is reduced and quality of a final product is improved.

Although the case in which the base 60 is applied to the hard disk drive will be mainly described in the present specification, it is obvious to those skilled in the art that the base 60 may be selectively applied to various disk drives such as an optical disk drive, and the like, in addition to the hard disk drive. Particularly, according to the preferred embodiment of the present invention, the base plate 61 and the double bent part 62 extended from the base plate 61 and doubly bent from the outer edge of the base plate 61 are formed, thereby making it possible to increase structural rigidity of the base 60. To this end, the base 60 may be manufactured so that the thickness (See a and b of FIG. 2) of the plate material forming the base plate 61 including the central portion of the base 60 and the thickness (See c of FIG. 2) of the plate material forming the double bent part 62 extended from the base plate 61 and doubly bent from the outer edge of the base plate have a relative difference therebetween. That is, a plate material having a relative thick thickness is used in order to increase the rigidity of a flat base plate 61, and a plate material having a thickness relatively thinner than that of the plate material of the base plate 61 is used in order to form a bent part of the double bent part 62. Particularly, it will be appropriate that the base plate 61 on which a motor to be described below is seated is formed to have the thickness (See b of FIG. 2) thicker than the thickness (See c of FIG. 2) of the plate material forming the double bent part 62.

The double bent part 62 may be doubly bent from the outer edge of the base plate 61. As shown in FIGS. 1 and 2, the base 60 may be configured to include the flat base plate 61 and the double bent part 62 doubly bent from the outer edge of the base plate 61. The double bent part 62 may be configured to include a first bent part 62a extended upwardly from one surface of the base plate 61 and bent outwardly of the base plate 61 and a second bent part 62c extended from the first bent part 62a and again bent downwardly toward the other surface of the base plate 61, as shown in FIG. 2. The first bent part 62a and the second bent part 62c may be bent at a right angle, respectively, as shown in FIG. 2. However, a bent angle of the first and second bent parts 62a and 62c is not limited thereto.

The first bent part 62a and the second bent part 62c may have a flat part 62b formed therebetween. When the flat part 62b is formed in the double bent part 62, the structural rigidity of the base 60 may be increased. In order to form the flat part 62b, it is appropriate to use a plate material having a thickness relatively thinner than that of the plate material forming the base plate 61. More specifically, when the thickness (See a and b of FIG. 2) of the plate material forming the base plate 61 is 0.8 or more to 1.0 mm or less, the thickness (See c of FIG. 2) of the plate material forming the double bent part 62 may be 0.6 or more to below 0.8. Particularly, when the spindle motor and other components are seated at the central portion of the base plate 61 of the base 60, it is advantageous that the thickness (See a of FIG. 2) of the plate material at the central portion by the press processing is thicker than those of other portions in order to maintain support force of the base 60. However, the double bent part 62 may be manufactured using a plate material having a thickness relatively thinner than that of the plate material of the base plate 61, since it is difficult to the double bent part 62 by doubly bending an excessively thick plate material in order to form the flat part 62b for increasing the structural rigidity as described above.

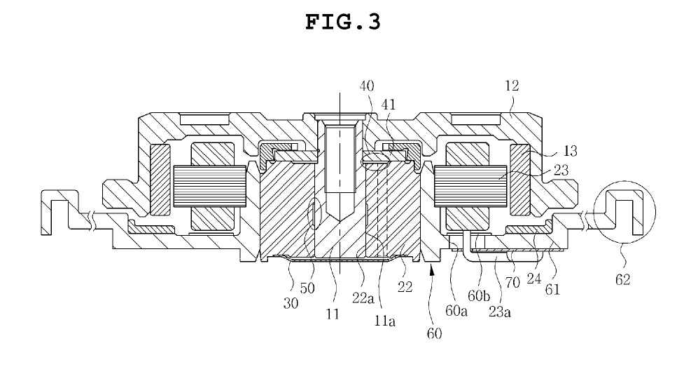

FIG. 3 is a partial cross-sectional view of a hard disk drive including a spindle motor seated on the base for a hard disk drive according to the preferred embodiment of the present invention.

The hard disk drive according to the preferred embodiment of the present invention may include a spindle motor seated on a seat part 63 of a base 60, wherein the spindle motor is configured to include: a shaft forming a rotation center of the motor; a sleeve receiving the shaft therein and rotatably supporting the shaft; the base 60 having one side surface coupled to an outer side surface of the sleeve so as to enclose the outer side surface of the sleeve to support the sleeve and having a core mounted on an inner side surface thereof, the core having a coil wound therearound; and a hub coupled to an upper portion of the shaft in an axial direction, having one side end bent in a downward axial direction, and having a rotor magnet formed on an inner side surface thereof so as to correspond to the core in a radial direction, the base 60 including a base plate 61 including the seat part 63 on which the spindle motor is seated; and a double bent part 62 doubly bent from an outer edge of the base plate 61, and a thickness of a plate material forming the double bent part 62 being thinner than that of a plate material forming the base plate 61.

Here, the base 60 may be the base 60 for a hard disk drive described above. Therefore, since the respective examples and acting effects of the base plate 61 and the double bent part 62 configuring the base 60 are the same as those of the base 60 described above, an overlapped detailed description will be omitted. In the hard disk drive according to the preferred embodiment of the present invention, each component of the spindle motor seated on the base 60 and operations thereof will be mainly described.

The shaft 11 forms the center axis around which the spindle motor rotates and has generally a cylindrical shape. Although the case in which the thrust plate 41 is inserted into an upper end portion of the shaft 11 so as to be perpendicular to the axial direction is shown in FIG. 1, the thrust plate 41 may be inserted into a lower end portion of the shaft so as to be perpendicular to the axial direction as well as the upper end portion of the shaft 11. In order to fix the thrust plate 41 to the shaft 11, separate laser welding, or the like, may be performed. However, it is obvious to those skilled in the art that the thrust plate 41 may be press-fitted into and be coupled to the shaft 11 by being applied with a predetermined pressure. In order to form a thrust dynamic pressure bearing part 40 by the fluid dynamic pressure bearing, dynamic pressure may be generated between the sleeve 22 and one surface of a hub 12 facing the sleeve 22 without a separate thrust plate 41.

The sleeve 22, which is to rotatably support the shaft 11, may support the shaft 11 so that the upper end of the shaft 11 is protruded in the upward axial direction and have a hollow cylindrical shape, such that it may receive the shaft 11 therein by inserting the shaft 11 into a hollow thereof, as shown in FIG. 3. The sleeve 22 may be formed by forging copper (Cu) or aluminum (Al) or sintering a Cu—Fe-based alloy powder or a SUS-based powder. A radial dynamic pressure bearing part 50 by fluid dynamic pressure may be formed between an inner peripheral surface 22a of the sleeve 22 and an outer peripheral surface 11a of the shaft 11 facing the sleeve 22. In order to form the radial dynamic pressure bearing part 50, a radial dynamic pressure generation groove (not shown) is formed in an inner peripheral surface 22a of the sleeve 22 facing an outer peripheral surface l la of the shaft 11, and an operating fluid (for example, oil, or the like) is stored between the inner peripheral surface 22a of the sleeve 22 and the outer peripheral surface 11 a of the shaft 11. The radial dynamic pressure generation groove generates fluid dynamic pressure using the operating fluid stored between the sleeve 22 and the shaft 11 at the time of rotation of the shaft 11, thereby making it possible to allow the shaft 11 and the sleeve 22 to be maintained in a state in which they do not contact each other. The radial dynamic pressure generation groove may also be formed in the outer peripheral surface 11a of the shaft 11 forming the radial dynamic pressure bearing part 50 by the fluid dynamic pressure.

The thrust plate 41 is press-fitted into the shaft 11 so as to be perpendicular to the axial direction of the shaft 11. The thrust plate 41 may be formed integrally with the shaft 11 or be formed separately from the shaft 11 and then coupled to the shaft 11. The thrust plate 41, which is to form the thrust dynamic pressure bearing part 40, may include the dynamic pressure generation groove (not shown) formed in the upper surface thereof in the axial direction as described above. Since other detailed descriptions are overlapped with the above-mentioned description, it will be omitted.

The base 60 has one surface coupled to the outer peripheral surface of the sleeve 22 so as to enclose the outer peripheral surface of the sleeve 22 so that the sleeve 22 including the shaft 11 is coupled to an inner side thereof. The base 60 has the core 23 coupled to the other surface thereof opposite to one surface thereof so as to correspond to the rotor magnet 13 mounted on an inner side surface of a side surface portion 12a of the hub 12 in the radial direction, wherein the core 23 has the coil 23a wound therearound.

Particularly, according to the preferred embodiment of the present invention, as described above, the plate material forming the base plate 61 and the plate material forming the double bent part 62 doubly bent from the outer edge of the base 60 have a relative difference in a thickness therebetween, thereby making it possible to always maintain the rigidity of the base 60. Therefore, even at the time of manufacturing the base 60 by the press processing, the rigidity of the base 60 may be maintained and a degree of freedom in a design according to the thickness of the plate material used at the time of the press processing may be further increased.

The press processing may be performed using various metals such as aluminum, steel, and the like, particularly, a metal material having rigidity. A conductive adhesive (not shown) for conduction between the base 60 and the sleeve 22 may be connected to and formed on a lower end surface of a portion at which the base 60 and the sleeve 22 are bonded to each other. This conductive adhesive allows excessive charges generated at the time of operation of the motor to be conducted to the base 60 to flow to the outside, thereby making it possible to improve reliability of the motor operation.

The core 23 is generally formed by stacking a plurality of thin metal plates and is fixedly disposed on the base 60 including a flexible printed circuit board 70. A plurality of through-holes 60a through which the coil 23a wound around the core 23 is led and passes may be formed in a lower end surface of the base 60, respectively, and the coil 23a led through the through-holes 21a may be soldered to the flexible printed circuit board 70 to thereby be supplied with external power. In order to insulate the coil 23a passing through the through-hole 21a of the base 60 and the base 60 from each other, an insulating sheet 61b may be formed at an inlet portion of the through-hole 21a.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in the axial direction. The hub 12 has the rotor magnet 13 mounted on the inner side surface of the side portion thereof so as to face the core 23 of the base 60 to be described below in the radial direction. The core 23 generates a magnetic flux while forming a magnetic field when current flows. The rotor magnet 13 facing the core 23 includes N and S poles repeatedly magnetized in a circumferential direction to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

As shown in FIG. 3, the cover member 30 is coupled to the sleeve 22 in order to cover an axial lower end surface of the sleeve 22 including the shaft 11. The cover member 30 includes a dynamic pressure generation groove (not shown) formed in an inner side surface thereof facing the lower end surface 11b of the shaft 11, thereby making it possible to form a thrust dynamic pressure bearing part. The cover member 30 may have a structure in which it is coupled to a distal end of the sleeve 22, such that the oil, which is the operating fluid, may be stored therein.

Components of the spindle motor according to the preferred embodiment of the present invention and an operation relationship therebetween will be briefly described below with reference to FIG. 3.

A rotor 10 includes the shaft 11 becoming a rotation axis and rotatably formed and the hub 12 having the rotor magnet 13 attached thereto, and a stator 20 includes the base 60, the sleeve 22, the core 23, and a pulling plate 24. Each of the core 23 and the rotor magnet 13 is attached to an outer side of the base 60 and an inner side of the hub 12 while facing each other. When current is applied to the core 23, a magnetic flux is generated while a magnetic field is formed. The rotor magnet 13 facing the core 23 includes repeatedly magnetized N and S poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 60 so as to correspond to the rotor magnet 13 in the axial direction. The pulling plate 24 and the rotor magnet 13 have attractive force acting therebetween, thereby making it possible to stably rotate the motor.

As set forth above, according to the preferred embodiments of the present invention, the base for a hard disk drive is structurally changed, thereby making it possible to increase the rigidity of the base.

In addition, it is possible to overcome a limitation in a degree of freedom in a design due to a limitation in a thickness of a plate material generated in the case in which the base is manufactured by the press processing.

Further, the base is structurally changed, thereby making it possible to increase the rigidity of the base without increasing the thickness of the plate material.

Furthermore, the double bent part is formed at an outer side of the base, thereby making it possible to prevent distortion of the base.

Moreover, the plate material of the central portion of the base and the plate material of the double bent part formed at the outer side of the base have a relative difference in a thickness therebetween, thereby making it possible to secure the rigidity at both of the central portion of the base and the outer side of the base.

In addition, the distortion, or the like, of the base is prevented to increase the rigidity of the base, thereby making it possible to improve the driving performance of the spindle motor seated on the base.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A base for a hard disk drive comprising:
a base plate; and
a double bent part doubly bent from an outer edge of the base plate,
wherein a thickness of a plate material forming the double bent part is thinner than that of a plate material forming the base plate.

2. The base for a hard disk drive as set forth in claim 1, wherein the double bent part includes:
a first bent part extended upwardly from one surface of the base plate and bent outwardly of the base plate; and
a second bent part extended from the first bent part and again bent downwardly toward the other surface of the base plate.

3. The base for a hard disk drive as set forth in claim 1, wherein the first bent part and the second bent part have a flat part formed therebetween, the flat part being in parallel with one surface of the base plate.

4. The base for a hard disk drive as set forth in claim 1, wherein when the thickness of the plate material forming the base plate is 0.8 or more to 1.0 mm or less, the thickness of the plate material forming the double bent part is 0.6 or more to below 0.8 mm.

5. The base for a hard disk drive as set forth in claim 1, wherein the thickness of the plate material forming the double bent part is thinner than that of the plate material forming a central portion of the base plate including a seat part on which a spindle motor is seated.

6. The base for a hard disk drive as set forth in claim 5, wherein when the thickness of the plate material forming the central portion of the base plate is 0.8 or more to 1.0 mm or less, the thickness of the plate material forming the double bent part is 0.6 or more to below 0.8 mm.

7. A hard disk drive including a spindle motor seated on a seat part of a base, wherein the spindle motor includes:
a shaft forming a rotation center of the motor;
a sleeve receiving the shaft therein and rotatably supporting the shaft;
the base having one side surface coupled to an outer side surface of the sleeve so as to enclose the outer side surface of the sleeve to support the sleeve and having a core mounted on an inner side surface thereof, the core having a coil wound therearound; and
a hub coupled to an upper portion of the shaft in an axial direction, having one side end bent in a downward axial direction, and having a rotor magnet formed on an inner side surface thereof so as to correspond to the core in a radial direction,
the base including:
a base plate including the seat part on which the spindle motor is seated; and
a double bent part doubly bent from an outer edge of the base plate, and a thickness of a plate material forming the double bent part being thinner than that of a plate material forming the base plate.

8. The hard disk drive as set forth in claim 7, wherein the double bent part includes:
a first bent part extended upwardly from one surface of the base plate and bent outwardly of the base plate; and
a second bent part extended from the first bent part and again bent downwardly toward the other surface of the base plate.

9. The hard disk drive as set forth in claim 7, wherein the first bent part and the second bent part have a flat part formed therebetween, the flat part being in parallel with one surface of the base plate.

10. The hard disk drive as set forth in claim 7, wherein when the thickness of the plate material forming the base plate is 0.8 or more to 1.0 mm or less, the thickness of the plate material forming the double bent part is 0.6 or more to below 0.8 mm.

11. The hard disk drive as set forth in claim 7, wherein the thickness of the plate material forming the double bent part is thinner than that of the plate material forming a central portion of the base plate including a seat part on which a spindle motor is seated.

12. The hard disk drive as set forth in claim 7, wherein when the thickness of the plate material forming the central portion of the base plate is 0.8 or more to 1.0 mm or less, the thickness of the plate material forming the double bent part is 0.6 or more to below 0.8 mm.
